(19) United States
(12) Patent Application Publication
(10) Pub. No.: US 2026/0346456 A1
(43) Pub. Date: Nov. 5, 2026

(54) ROBOT CONTROL DEVICE, ROBOT CONTROL METHOD, AND PROGRAM

(71) Applicant: Panasonic Intellectual Property Management Co., Ltd., Osaka (JP)

(72) Inventors: Takuma YABUTA, Kanagawa (JP); Junya KUWADA, Osaka (JP); Akihiro EBINA, Kyoto (JP); Nobuki NISHIO, Osaka (JP); Shiori YOKOTA, Osaka (JP); Yuta KAMEMURA, Fukuoka (JP)

(73) Assignee: Panasonic Intellectual Property Management Co., Ltd., Osaka (JP)

(21) Appl. No.: 19/486,599

(22) PCT Filed: Mar. 28, 2024
(86) PCT No.: PCT/JP2024/012554

§ 371 Date: Nov. 21, 2025

(30) Foreign Application Priority Data
May 24, 2023 (JP) 2023-085428

(51) Int. Cl. B25J 9/16

(52) U.S. Cl. CPC B25J 9/1692

(57) ABSTRACT

A robot control device receives input of position information of an object to be operated by a robot device in a first coordinate system and an operation setting of a part constituting the robot device, acquires a parameter of the part constituting the robot device and a correction value for coordinate transformation between a second coordinate system corresponding to the part constituting the robot device and the first coordinate system, generates a transformation table for transforming the position information in the first coordinate system into position information in the second coordinate system based on the correction value, the parameter, and the operation setting, and transforms the position information in the first coordinate system into the position information in the second coordinate system using the transformation table, and generates a control command for the part constituting the robot device using the position information in the second coordinate system.

### TECHNICAL FIELD

The present disclosure relates to a robot control device, a robot control method, and a program.

### BACKGROUND ART

Conventionally, a system for performing various operations on behalf of a person, such as carrying of a load using a device such as a robot, has been widely used. In such a system, parameters related to the operation of the robot are set and used by the user in consideration of the configuration of the robot and the like. For example, Patent Literature 1 discloses a configuration for facilitating rewriting and selection of control amount and coordinate transformation data for data related to control of a robot device.

### CITATION LIST

### Patent Literature

PTL 1: Unexamined Japanese Patent Publication No. H5-324051

### SUMMARY OF THE INVENTION

The present disclosure has been made in view of the above-described conventional circumstances, and an object of the present disclosure is to facilitate parameter setting regarding robot control and to improve convenience of a system including a robot device as compared with the conventional case.

The present disclosure provides a robot control device including: an input unit that receives position information of an object to be operated by a robot device in a first coordinate system, setting information of a part constituting the robot device, and name information of the part; an acquisition unit that acquires, from a database, a parameter and a coordinate transformation frame of the part corresponding to the name information received by the input unit, the database storing the parameter and the coordinate transformation frame of the part in association with the name information of the part constituting the robot device; a generation unit that specifies a correction value based on the coordinate transformation frame acquired by the acquisition unit, the correction value being a difference value between the first coordinate system and a second coordinate system corresponding to the part, and generates a transformation table for transforming position information in the first coordinate system into position information in the second coordinate system based on the setting information of the part received by the input unit, the parameter of the part acquired by the acquisition unit, and the specified correction value; and a controller that transforms position information in the first coordinate system into position information in the second coordinate system using the transformation table generated by the generation unit, and generates a control command for the part constituting the robot device using the position information in the second coordinate system.

Further, the present disclosure provides a robot control method including: receiving position information of an object to be operated by a robot device in a first coordinate system, setting information of a part constituting the robot device, and name information of the part; acquiring, from a database, a parameter and a coordinate transformation frame of the part corresponding to the received name information the database storing the parameter and the coordinate transformation frame of the part in association with the name information of the part constituting the robot device; specifying a correction value based on the acquired coordinate transformation frame, the correction value being a difference value between the first coordinate system and a second coordinate system corresponding to the part, and generating a transformation table for transforming position information in the first coordinate system into position information in the second coordinate system based on the received setting information of the part, the acquired parameter of the part, and the specified correction value; and transforming position information in the first coordinate system into position information in the second coordinate system using the generated transformation table, and generating a control command for the part constituting the robot device using the position information in the second coordinate system.

Further, the present disclosure provides a program for causing a computer to execute a robot control method including: receiving position information of an object to be operated by a robot device in a first coordinate system, setting information of a part constituting the robot device, and name information of the part; acquiring, from a database, a parameter and a coordinate transformation frame of the part corresponding to the received name information, the database storing the parameter and the coordinate transformation frame of the part in association with the name information of the part constituting the robot device; specifying a correction value based on the acquired coordinate transformation frame, the correction value being a difference value between the first coordinate system and a second coordinate system corresponding to the part, and generating a transformation table for transforming position information in the first coordinate system into position information in the second coordinate system based on the received setting information of the part, the acquired parameter of the part, and the specified correction value; and transforming position information in the first coordinate system into position information in the second coordinate system using the generated transformation table, and generating a control command for the part constituting the robot device using the position information in the second coordinate system.

Furthermore, the present disclosure provides a robot control device including: an input unit that receives input of position information of an object to be operated by a robot device in a first coordinate system and an operation setting of a part constituting the robot device; an acquisition unit that acquires, based on the operation setting, a parameter of the part constituting the robot device and a correction value for coordinate transformation between a second coordinate system corresponding to the part constituting the robot device and the first coordinate system; a generation unit that generates a transformation table for transforming the position information in the first coordinate system into position information in the second coordinate system based on the correction value, the parameter, and the operation setting; and a controller that transforms the position information in the first coordinate system into the position information in the second coordinate system by using the transformation table, and generates a control command for the part constituting the robot device by using the position information in the second coordinate system.

Further, the present disclosure provides a robot control method including: receiving input of position information of an object to be operated by a robot device in a first coordinate system and an operation setting of a part constituting the robot device; acquiring, based on the operation setting, a parameter of a part constituting the robot device and a correction value for coordinate transformation between a second coordinate system corresponding to the part constituting the robot device and the first coordinate system; generating a transformation table for transforming the position information in the first coordinate system into position information in the second coordinate system based on the correction value, the parameter, and the operation setting; and transforming the position information in the first coordinate system into the position information in the second coordinate system using the transformation table, and generating a control command for the part constituting the robot device using the position information in the second coordinate system.

Further, the present disclosure provides a program for causing a computer to execute a robot control method including: receiving input of position information of an object to be operated by a robot device in a first coordinate system and an operation setting of a part constituting the robot device; acquiring, based on the operation setting, a parameter of a part constituting the robot device and a correction value for coordinate transformation between a second coordinate system corresponding to the part constituting the robot device and the first coordinate system; generating a transformation table for transforming the position information in the first coordinate system into position information in the second coordinate system based on the correction value, the parameter, and the operation setting; and transforming the position information in the first coordinate system into the position information in the second coordinate system using the transformation table, and generating a control command for the part constituting the robot device using the position information in the second coordinate system.

Note that those obtained by transforming arbitrary combinations of the above components and expressions of the present disclosure among methods, apparatuses, systems, storage media, computer programs, and the like are also effective as aspects of the present disclosure.

According to the present disclosure, it is possible to more easily set parameters related to robot control than before and to improve convenience of a system including a robot device than before.

### BRIEF DESCRIPTION OF THE DRAWINGS

FIG. 1 is a schematic diagram for explaining coordinate transformation in parameter setting of a robot.

FIG. 2 is a block diagram illustrating an example of a system configuration according to an exemplary embodiment of the present invention.

FIG. 3 is a sequence diagram related to the operation of a system according to an exemplary embodiment of the present invention.

FIG. 4 is a flowchart of processing of a control system according to an exemplary embodiment of the present invention.

FIG. 5 is a schematic diagram illustrating a configuration example of a setting screen according to an exemplary embodiment of the present invention.

FIG. 6 is a schematic diagram illustrating a configuration example of a setting screen according to an exemplary embodiment of the present invention.

FIG. 7 is a schematic diagram illustrating a configuration example of a setting screen according to an exemplary embodiment of the present invention.

FIG. 8 is a schematic diagram illustrating a configuration example of a setting screen according to an exemplary embodiment of the present invention.

FIG. 9 is a schematic diagram illustrating a configuration example of a setting screen according to an exemplary embodiment of the present invention.

### DESCRIPTION OF EMBODIMENT

### Background of Present Disclosure

Conventionally, a system that causes a robot to perform various operations instead of a person has been widely used. With regard to control of the robot, a user sets in advance a movement position of the robot, position information of a target on which work is performed by the robot, and the like. One robot can provide various movable ranges and operations according to its configuration, a functional unit (hereinafter, also referred to as an end effector) provided at a distal end position of the robot, and the like. Furthermore, a plurality of robots may perform work in cooperation with one target. In such a system, a plurality of coordinate systems are defined according to the configuration and number of robots, and are used while converting values between the coordinate systems. The user needs to set parameters for controlling the robot while taking into account the relationship between the coordinate systems, and high knowledge and proficiency regarding the setting have been required. For example, in Patent Literature 1, upon setting by the user, operability in consideration of the relationship between the coordinate systems has not been sufficiently studied.

Hereinafter, an exemplary embodiment specifically disclosing a robot control method, a robot control device, and a program according to the present disclosure will be described in detail with appropriate reference to the accompanying drawings. However, unnecessarily detailed description may be omitted. For example, a detailed description of a well-known matter or a repeated description of substantially the same configuration may be omitted. This is to avoid unnecessary redundancy of the following description and to facilitate understanding of those skilled in the art. Note that the accompanying drawings and the following description are provided for those skilled in the art to fully understand the present disclosure, and are not intended to limit the subject matter described in the claims.

### First Exemplary Embodiment

### Example of Coordinate Transformation

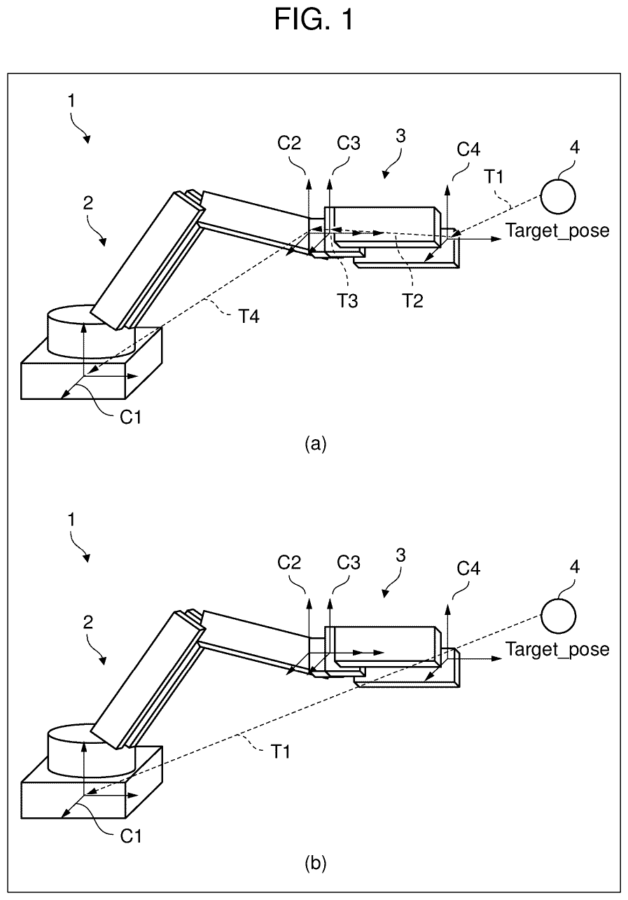

FIG. 1 is a schematic diagram illustrating a conventional configuration and coordinate transformation according to an exemplary embodiment of the present invention. Here, an example in which a robot hand as an example of an end effector is provided at a distal end portion of a robot arm in one robot device will be described. FIG. 1(a) illustrates an example of conventional coordinate transformation, and FIG. 1(b) illustrates an example of coordinate transformation according to an exemplary embodiment of the present invention.

Robot device 1 includes robot arm 2 and robot hand 3. Robot arm 2 includes, for example, six axes. Robot hand 3 is configured to be able to hold a target, and in the present exemplary embodiment, an example is shown in which robot hand 3 includes two fingers. Note that the configuration of robot hand 3 is not particularly limited, and the number of fingers may be three or more, or the fingers may have joints. In addition, the end effector provided at the distal end portion of robot arm 2 is not limited to the robot hand, and may be a rod-shaped portion or may have another function such as a camera. In addition, object 4 will be described as an example of an object to be operated by robot device 1.

In the example of robot device 1 illustrated in FIG. 1, four coordinate systems C1, C2, C3, and C4 are defined corresponding to each component. Coordinate system C1 is a coordinate system at a reference position of robot arm 2, and is also referred to as an “arm reference coordinate system”. Coordinate system C2 is a coordinate system at the distal end position of robot arm 2, and is also referred to as an “arm distal end coordinate system”. Coordinate system C3 is a coordinate system at the reference position of robot hand 3, and is also referred to as a “hand reference coordinate system”. Coordinate system C4 is a coordinate system at a target position (for example, a position at which an operation is performed) of robot hand 3, and is also referred to as a “hand target coordinate system”. Here, it is assumed that the coordinate system is a three-dimensional coordinate system including three axes of an x axis, a y axis, and a z axis, and parameters of each coordinate system can be transformed from each other.

Although not illustrated in FIG. 1, when a plurality of robot devices are used, coordinate system CO set for the entire space in which the robot devices are installed is also defined. Coordinate system CO is also referred to as a “system coordinate system”. Note that the setting of the above-described coordinate system is an example, and more coordinate systems may be defined according to the configuration, arrangement, and the like of the robot device. In addition, some coordinate systems may coincide with each other.

In the conventional configuration illustrated in FIG. 1(a), for example, it is assumed that position coordinates of object 4 as an operation target by robot device 1 are indicated by a parameter Target_pose. In parameter Target_pose, coordinates of each axis and values of roll, pitch, and yaw may be defined. Here, as an example, parameter Target_pose will be described as a parameter in the system coordinate system.

In the conventional method, when the control parameter of each part of robot device 1 is set corresponding to parameter Target_pose of the system coordinate system, it is necessary to specify the origin position of each coordinate system and then perform coordinate transformation on the parameter Target_pose in the order of coordinate system C4→C3→C2→C1. Therefore, in order to set parameter Target_pose as a control parameter of coordinate system C1, it is necessary to perform coordinate transformation four times in total as indicated by coordinate transformations T1, T2, T3, and T4. In other words, the user needs to set the transformed control parameters corresponding to the respective coordinate systems in consideration of the relationship between the respective coordinate systems. At this time, since the definition and relationship of the coordinate system are different depending on the configuration of the robot arm, the way of attaching the end effector, and the like, the order of application of the transformation matrix and the like change. As a result, the parameter setting of the robot device requires a certain degree of knowledge and a certain degree of proficiency of the configuration of the robot and the parameter setting.

On the other hand, in an exemplary embodiment of the present invention illustrated in FIG. 1(b), for example, when parameter Target_pose in the system coordinate system is designated by the user, desired coordinate transformation is performed on the system side, so that the user does not have to perform setting in consideration of the relationship between the coordinate systems as in the conventional method. For example, the system side performs coordinate transformation T1 once such that parameter Target_pose of the system coordinate system becomes the value of coordinate system C1. That is, the user sets the position information of the object to be operated without considering the configuration of robot device 1, and realizes a configuration that does not require user-based coordinate transformation.

### Device Configuration

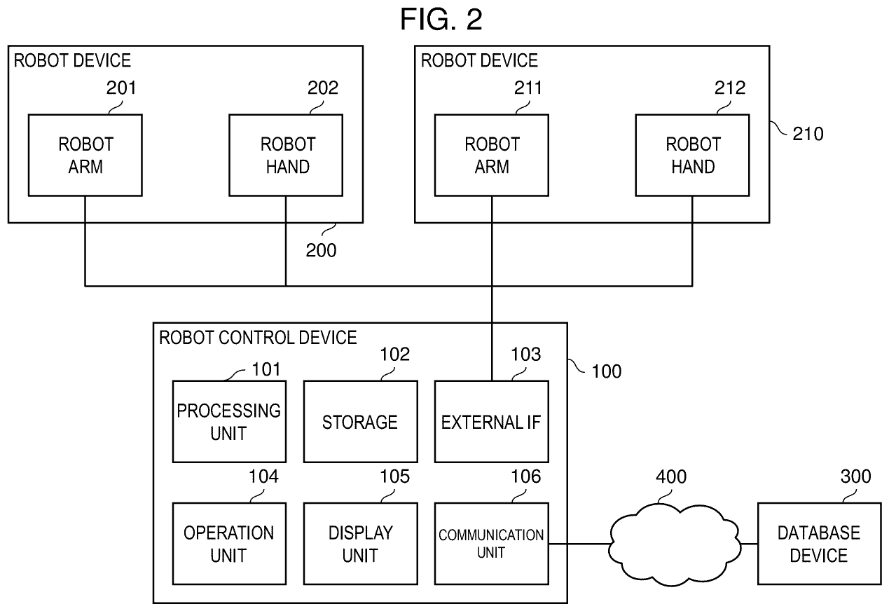

FIG. 2 is a schematic diagram illustrating an example of a system configuration according to the first exemplary embodiment of the present invention. The system according to the present exemplary embodiment includes robot control device 100, robot devices 200 and 210, and database device 300.

Robot control device 100 cooperates with database device 300, which is an external device, to control the operations of robot devices 200 and 210. Robot control device 100 may include, for example, a personal computer (hereinafter, PC), a dedicated device, or the like. Robot control device 100 includes processing unit 101, storage 102, external interface (IF) 103, operation unit 104, display unit 105, and communication unit 106. Each part included in robot control device 100 may be configured to be able to communicate with each other via an internal bus (not illustrated).

Processing unit 101 executes various functions described later by reading and executing various programs and data stored in storage 102. Processing unit 101 may include, for example, a Central Processing Unit (hereinafter, CPU), a Micro Processing Unit (hereinafter, MPU), a Digital Signal Processor (hereinafter, DSP), a Graphical Processing Unit (hereinafter, GPU), a Field Programmable Gate Array (hereinafter, FPGA), or the like.

Storage 102 is a storage region for storing and retaining various types of data, and may include, for example, a Read Only Memory (hereinafter, ROM) and a Hard Disk Drive (hereinafter, HDD), each of which is a nonvolatile storage region, and a Random Access Memory (hereinafter, RAM) that is a volatile storage region.

External IF 103 is an interface connected to robot devices 200 and 210 and configured to transmit and receive various types of data. Any communication standard may be used for connection by external IF 103 regardless of wired or wireless connection. Operation unit 104 includes a mouse, a keyboard, and the like, and is used when receiving input of an instruction or data by a user. Display unit 105 displays various types of data, processing results, and the like.

Communication unit 106 communicates with an external device via a wired/wireless network 400 and transmits and receives various types of data and signals. The communication system by communication unit 106 is not particularly limited, and may correspond to a plurality of communication systems. For example, a wide area network (hereinafter, WAN), a local area network (hereinafter, LAN), power line communication, near-field wireless communication (for example, Bluetooth (registered trademark) or Wi-Fi (registered trademark)), or the like may be used. In the present exemplary embodiment, communication unit 106 is connected to database device 300 via at least network 400.

Robot devices 200 and 210 are systems capable of performing an arbitrary operation on a target, and have, for example, a configuration as illustrated in FIG. 1. Robot device 200 includes robot arm 201 and robot hand 202 which is an example of an end effector. Similarly, robot device 210 includes robot arm 211 and robot hand 212 which is an example of an end effector. In the present exemplary embodiment, two robot devices 200 and 210 are shown, but more robot devices may be provided. Furthermore, in the present example, robot device 200 and robot device 210 will be described as having the same configuration, but may have separate functions. For example, a camera that can be set on a setting screen to be described later, a detector that can perform a touch sensing operation, or the like may be used as the end effector. Furthermore, two or more end effectors may be provided at the distal end of one robot arm. Further, in the present exemplary embodiment, an example in which a plurality of robot devices are controlled by one robot control device 100 is shown, but one robot device may be controlled by one robot control device.

Database device 300 holds and manages various types of data related to control of the robot device. In the present exemplary embodiment, database device 300 manages data based on the configuration and the like of each of robot devices 200 and 210, and provides the data in response to a request from robot control device 100. Database device 300 may be configured as a server device on a cloud.

Network 400 includes, for example, the Internet or the like, and serves as a data transmission/reception path between robot control device 100 and database device 300. Note that connection between robot control device 100 and each robot device may be performed via network 400.

### Processing Sequence

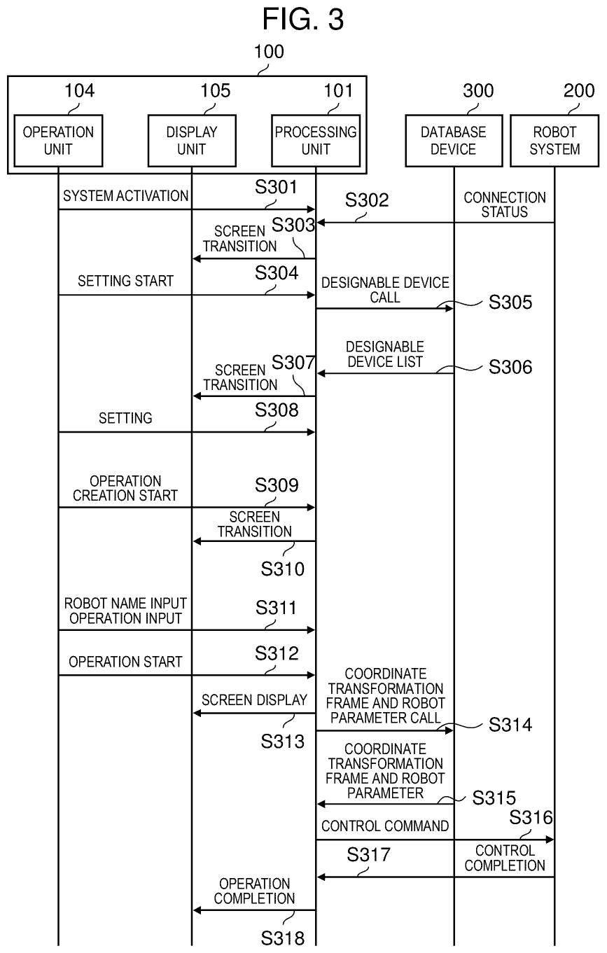

FIG. 3 is a diagram illustrating a processing sequence between devices of the system according to the present exemplary embodiment. Here, robot device 200 will be described as an example among a plurality of controllable robot devices.

Robot control device 100 receives an instruction to activate the system from the user via operation unit 104 (step S301). This instruction may be received via a screen generated by processing unit 101.

Robot control device 100 acquires information on a connection status from robot device 200 (step S302). The information acquired here may include information on the configuration and function of connected robot device 200. Robot device 200 may transmit various types of information in response to a request from robot control device 100, or may monitor robot control device 100 from robot device 200 side and transmit various types of information at a predetermined timing.

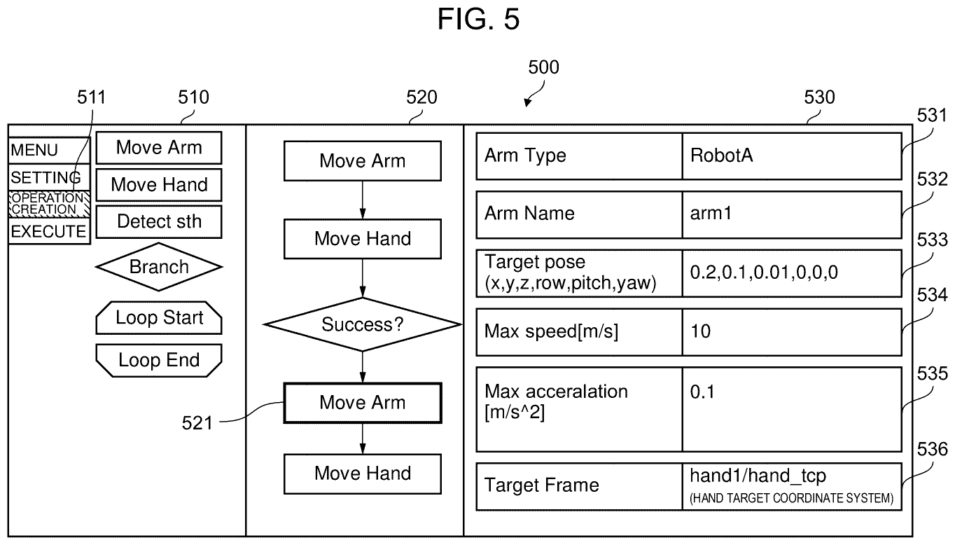

Robot control device 100 displays a setting screen for the robot information on display unit 105, based on the information of connected robot device 200 (step S303). The setting screen displayed here may be, for example, a top screen (not illustrated) for transitioning to various setting screens described with reference to FIGS. 5 to 9.

Robot control device 100 receives an instruction to start setting via operation unit 104 (step S304).

Due to the instruction received in step S304, robot control device 100 requests database device 300 to list settable devices based on the information of the robot device received in step S302 (step S305).

Database device 300 provides robot control device 100 with a list of settable devices in response to a request from robot control device 100 (step S306). The list may include, for example, information such as a settable part among parts constituting the connected robot device, a setting item thereof, a predefined parameter set (including fixed value/variable value), and the like.

Robot control device 100 configures a setting screen based on the list acquired in step S306 and displays the setting screen on display unit 105 (step S307).

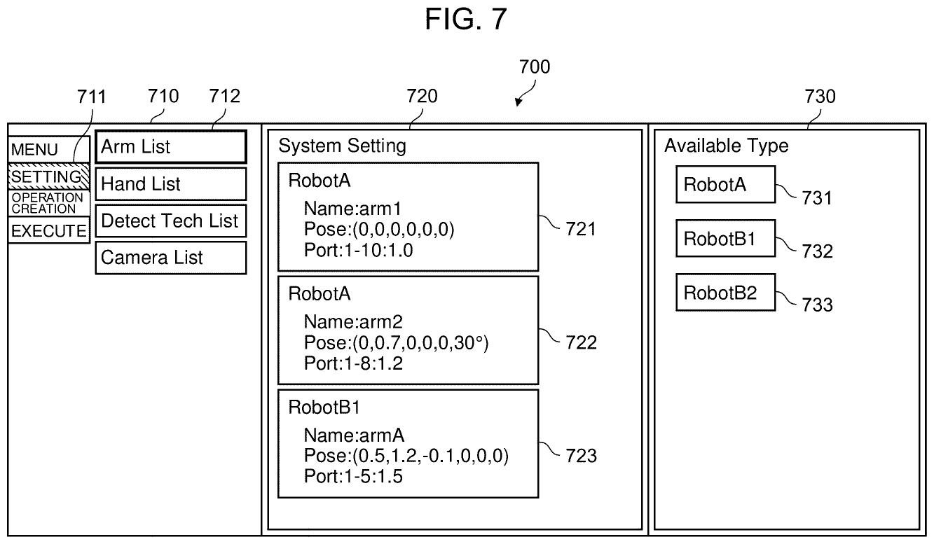

Robot control device 100 receives a setting related to each part of robot device 200 via operation unit 104 on the setting screen displayed in step S307 (step S308). Here, for example, as illustrated in FIGS. 7 to 9, the setting is performed by selecting a button of “setting” provided on the setting screen and further selecting a desired part from the list. An example of the setting will be described later together with the setting screen.

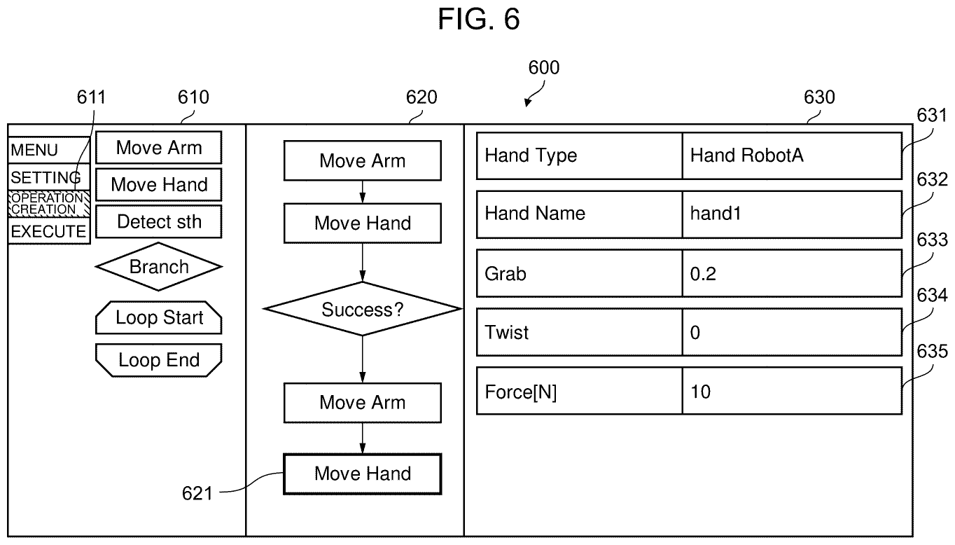

Robot control device 100 receives an instruction of operation creation start via operation unit 104 (step S309). For example, as illustrated in FIGS. 5 and 6, the instruction of operation creation start is performed by selecting the button of “operation creation” provided on the setting screen.

Robot control device 100 configures a setting screen based on the instruction of operation creation start received in step S309, and displays the setting screen on display unit 105 (step S310). A specific example of the setting screen will be described later with reference to FIGS. 5 and 6.

Robot control device 100 receives input of various settings such as the name of the robot and the operation of the robot via operation unit 104 (step S311). A specific example of the setting will be described later together with the setting screen.

Robot control device 100 receives an instruction of operation start of the robot device based on the setting input via operation unit 104 (step S312). Here, the instruction of operation start is performed, for example, by selecting the “execute” button provided on the setting screen as illustrated in FIG. 5.

Robot control device 100 configures a setting screen based on the instruction of operation start received in step S312, and displays the setting screen on display unit 105 (step S313). The display screen here may be a screen (not illustrated) indicating that the operation is being executed.

Robot control device 100 calls the coordinate transformation frame and the robot parameters from database device 300 based on the input setting. The coordinate transformation frame is data indicating a definition of a coordinate system defined corresponding to the configuration of the robot device and a relationship between the coordinate systems. More specifically, the information of the coordinate transformation frame indicates names of various coordinate systems as described above, and by specifying the coordinate transformation frame, it is possible to specify in which coordinate system the obtained coordinate value is a value. The robot parameter is information indicating a dimension (size), a movable range, a constraint, and the like of each part constituting the robot device. Specific examples of the coordinate transformation frame and the robot parameters will be described later with reference to FIGS. 5 to 9.

Database device 300 provides the coordinate transformation frame and the robot parameters to robot control device 100 in response to a request from robot control device 100 (step S315).

Robot control device 100 generates a command for robot device 200 using the various types of data acquired in step S315 and step S311. Furthermore, robot control device 100 transmits the generated command to robot device 200 to issue a command to execute an operation (step S316).

Robot device 200 executes an operation in accordance with a command from robot control device 100. Thereafter, after the operation is completed, robot device 200 notifies robot control device 100 of the completion (step S317).

Robot control device 100 configures a screen based on the notification from robot device 200, and displays that the operation in robot device 200 is completed (step S318). The display screen here may be a screen (not illustrated) indicating a result of the operation (including normal end, abnormal end, interruption, and the like.).

Note that a part of the processing of the sequence illustrated in FIG. 3 may be executed at another timing, or a part of the processing may be rearranged. For example, a part of the processing of steps S314 and S315 may be executed integrally with steps S305 and S306.

### Processing Flow

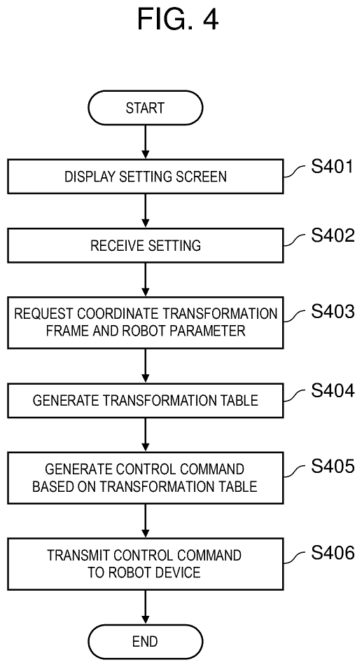

FIG. 4 is a flowchart of processing by robot control device 100 according to the present exemplary embodiment, and corresponds to a part of the sequence illustrated in FIG. 3. This processing flow may be realized, for example, by processing unit 101 of robot control device 100 reading and executing various types of programs and data stored in storage 102. Here, in order to simplify the description, processing subjects will be collectively described as robot control device 100. When this processing flow is disclosed, it is assumed that the processing up to step S306 in FIG. 3 is completed, setting for each robot device is enabled, and the robot device is also in an operable state.

Robot control device 100 displays a setting screen for the robot device (step S401). The setting screen here may be, for example, a screen that can transition to the setting screens of FIGS. 5 to 9.

Robot control device 100 receives the setting of the control parameter related to the robot device via the setting screen displayed in step S401 (step S402). The setting here includes, for example, position information (specifically, parameter of Target_pose described above) of the object to be operated in the system coordinate system and other control parameters. Specific examples of the setting item and the setting value will be described later with reference to FIGS. 5 to 9. Furthermore, robot control device 100 receives the instruction of operation start, thereby obtaining an instruction indicating that the setting of the control parameter is completed.

In response to the reception of the instruction of operation start, robot control device 100 calls the coordinate transformation frame and the robot parameter corresponding to the robot device corresponding to the setting received in step S402 from database device 300 (step S403). Then, robot control device 100 acquires various types of information from database device 300 in response to the call.

Robot control device 100 generates a transformation table for transforming the value of each coordinate system based on the information input in step S402 and the information acquired in step S403 (step S404). The transformation table is generated by applying robot parameters and setting information to a predefined coordinate transformation frame, and is used for parameter transformation between coordinate systems defined for each part of the robot device. For example, the coordinate transformation frame may be configured to generate a transformation table between a coordinate system defined by each of a plurality of components of the robot device and the coordinate system based on a relationship between the coordinate system and the system coordinate system, for example, a relative distance of an origin position, a direction of a coordinate axis, or the like. Coordinate transformation frame A corresponding to coordinate system A before transformation and coordinate transformation frame B corresponding to coordinate system B after transformation are taken as examples. By acquiring coordinate transformation frame A and coordinate transformation frame B, it is possible to specify the position of the origin of coordinate transformation frame B in coordinate transformation frame A. Then, the correction value, that is, the difference value between the coordinate systems is calculated using the specified origin, and is used when the transformation table is automatically generated. The correction value may include a difference between the origin in each of the x axis, the y axis, and the z axis and a difference in the rotation angle around each axis. A plurality of transformation tables may be generated according to the configuration of the robot device. For example, a transformation table between the system coordinate system and the arm reference coordinate system and a transformation table between the system coordinate system and the hand reference coordinate system may be generated.

Note that the configuration of the transformation table can vary depending on the setting information, the configuration and state of the designated robot device, and the like. Therefore, in the present exemplary embodiment, the transformation table is not held in advance by robot control device 100, but is appropriately generated after the setting information is input. With such a configuration, it is not necessary to hold in advance a transformation table in which various variations are assumed according to a combination of settings, and it is possible to suppress tight storage areas and the like. Note that the configuration of the transformation table may not change depending on a series of operations of the robot device, an immediately preceding operation, or the like. In such a case, the transformation table may be temporarily held, and the held transformation table may be diverted instead of the transformation table generation processing.

Robot control device 100 generates a control command for the robot device based on the transformation table generated in step S404 and the setting received in step S402 (step S405).

Robot control device 100 transmits the control command generated in step S405 to the robot device to be operated, and causes the robot device to execute the operation based on the control command (step S406). Then, the processing flow ends.

### Setting Screen Example

A configuration example of a setting screen related to the operation of the robot device according to the present exemplary embodiment will be described. Each setting screen described below is displayed on display unit 105 of robot control device 100 in a state where the user can operate the setting screen. In the example of the following screen, it is assumed that a plurality of robot devices are provided to be usable. In addition, as illustrated in FIG. 2, an example is illustrated in which the robot device includes at least a robot arm and a robot hand as an example of an end effector.

FIGS. 5 and 6 illustrate flowcharts of the operation of each robot device, and setting screens for the operation of each part of the robot device included in the flowcharts. These drawings are used, for example, in the process of step S309 of the processing sequence illustrated in FIG. 3. FIGS. 7 to 9 illustrate individual setting screens regarding the configuration and the like of each part of the robot device. These drawings are used, for example, in the process of step S308 of the processing sequence illustrated in FIG. 3.

FIG. 5 is a configuration example of setting screen 500 for setting a series of operations for the robot device, and here, illustrates an example of performing setting for the robot arm. In region 510, button 511 for creating an operation is selected. The robot device can perform one or a plurality of operations by operating a robot arm, a robot hand, or the like. On setting screen 500, a workflow including such one or more operations can be set. In region 510, a list of operations for defining the workflow is selectably shown. In the present exemplary embodiment, “Move Arm” indicating the operation of the robot arm, “Move Hand” indicating the operation of the robot hand, “Detect sth” indicating the operation of the detector, “Branch” indicating the condition determination, and “Loop Start” and “Loop End” indicating the start and end of the loop are selectable. Note that the items shown here are examples, and may be changed according to the configuration of the robot device.

In region 520, a workflow currently set is illustrated. In the present example, a workflow for executing operations in the order of “Move Arm”→“Move Hand”→“Condition Determination (Success?)”→“Move Arm”→“Move Hand” is defined. Furthermore, in the present example, operation process 521 is selected, which indicates a state of setting the operation of the robot arm. In the “Success?” as the condition determination, it is determined whether or not the operation so far has succeeded, and in a case where the operation has succeeded, the subsequent operation is executed.

In response to that operation process 521 of the robot arm is designated as a setting target, setting items for the robot arm are displayed in region 530. Setting item 531 designates a robot arm that performs an operation. Setting item 532 designates the name of the robot arm that performs the operation. In setting item 533, information of an object to be operated, that is, above-described Target_pose (coordinate value of each axis, and value of roll, pitch, yaw) is set. In setting item 534, a moving speed of the robot arm is set. In setting item 535, an acceleration related to movement of the robot arm is set. In setting item 536, the configuration of a part (here, robot hand) provided at the distal end portion of the robot arm is set. In the example illustrated in FIG. 5, a name “hand1” uniquely indicating the robot hand and “hand_tcp” uniquely indicating a coordinate system corresponding to the robot hand are designated. “hand_tcp” specifically corresponds to the origin position of the hand target coordinate system illustrated in FIG. 1, that is, the target position to be moved as the operation position of the robot hand. Note that the value of each setting item may be uniquely specified and displayed based on other setting items or already registered data. Furthermore, each setting item is an example, and some setting items may be omitted or other setting items may be added according to the configuration of the robot device.

FIG. 6 is a configuration example of setting screen 600 for setting a series of operations for the robot device, and here, an example of performing setting for the robot hand is illustrated. In setting screen 600, region 610 and region 620 are similar to region 510 and region 520 illustrated in FIG. 5. In region 610, button 611 for creating an operation is selected. In the present example, operation process 621 is selected from the set workflow, which indicates a state of setting the operation of the robot hand.

In response to that operation process 621 of the robot hand is designated as a setting target, setting items for the robot hand are displayed in region 630. Setting item 631 designates a robot hand that performs an operation. Setting item 632 designates the name of the robot hand that performs the operation. Setting item 633 designates a movement amount of the finger of the robot hand. For example, in the case of a robot hand as illustrated in FIG. 1, a distance between fingers may be designated. Setting item 634 designates a rotation angle of the wrist of the robot hand. In setting item 635, a gripping force of the robot hand is set. Note that the value of each setting item may be uniquely specified and displayed based on other setting items or already registered data. Furthermore, each setting item is an example, and some setting items may be omitted or other setting items may be added according to the configuration of the robot device.

FIG. 7 illustrates a list of the robot arms included in the robot device. For example, the robot arm included in the list can be selected on setting screen 500 illustrated in FIG. 5, for example.

In region 710, button 711 for list setting is selected. In addition, each list is illustrated in region 710 in order to set each part included in the robot device. In the present example, “Arm List” for setting the robot arm, “Hand List” for setting the robot hand, “Detect Tech List” for setting the detector, and “Camera List” for setting the camera are selectable. Here, button 712 is selected. Note that the items shown here are examples, and may be changed according to the configuration of the robot device.

In region 720, the settings of the already registered robot arms are shown. In region 730, a list of settable robot arms is shown. In the present example, selection items 731 to 733 of “RobotA”, “RobotB1”, and “RobotB2” are shown in region 730 as settable robot arms. Furthermore, in region 720, settings 721 to 723 are shown as a setting of the already registered robot arm.

For example, the following are included as setting parameters of setting 721 for the robot arm.
Setting target arm: RobotA
Name: arm1
Posture: (0, 0, 0, 0, 0, 0)
Port: 1-10: 1.0
   The setting target arm indicates a robot arm to be set. The name indicates a name arbitrarily set to the robot arm. The posture indicates a reference posture of the robot arm. The port indicates information on a port (interface) to which the robot arm is connected. Other settings also include setting parameters for similar items.

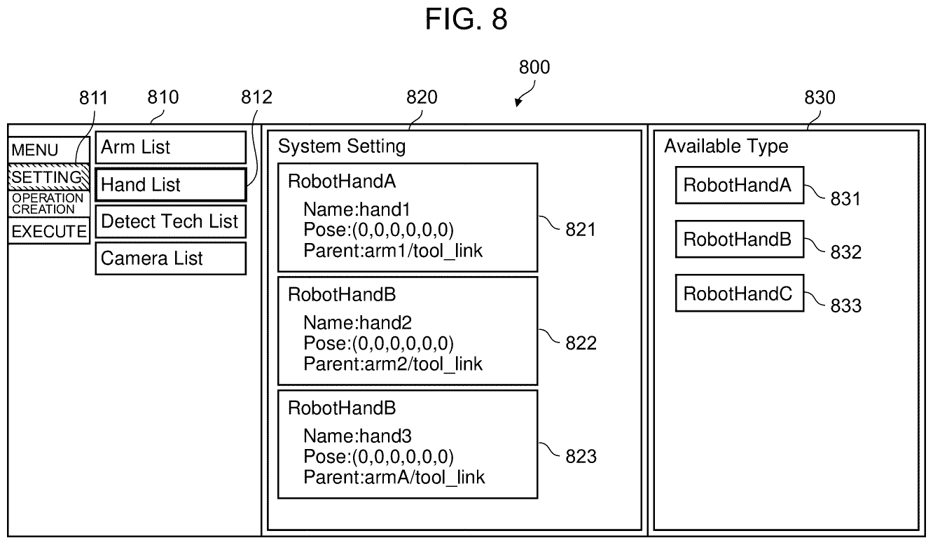

FIG. 8 illustrates a list of robot hands included in the robot device. For example, the robot hand included in the list can be selected on setting screen 600 illustrated in FIG. 6. The configuration of region 810 is similar to that of region 710 of setting screen 700 in FIG. 7. In region 810, button 811 for list setting is selected. Further, button 812 for setting the list of the robot hands is selected.

In region 820, the settings of the already registered robot hands are shown. In region 830, a list of settable robot hands is shown. In the present example, selection items 831 to 833 of “RobotHandA”, “RobotHandB”, and “RobotHandC” are shown in region 830 as the settable robot hands. Furthermore, in region 820, settings 821 to 823 are illustrated as settings of the already registered robot hands.

For example, the following are included as setting parameters of setting 821 for the robot hand.
Setting target hand: RobotHandA
Name: hand1
Posture: (0, 0, 0, 0, 0, 0)
Installation destination arm: arm1/tool_link
   The setting target hand indicates a robot hand to be set. The name indicates name information arbitrarily set to the robot hand. The posture indicates a reference posture of the robot hand, that is, a posture installed for the robot arm. The installation destination arm indicates information on the robot arm on which the robot hand is installed. Specifically, “arm1” uniquely indicating the installation destination arm and “tool_link” uniquely indicating the coordinate system of the robot arm are illustrated. Specifically, “tool_link” is position information for specifying the origin position of the arm distal end coordinate system illustrated in FIG. 1, that is, the origin position of the hand reference coordinate system in which the robot hand is installed. Other settings also include similar setting parameters.

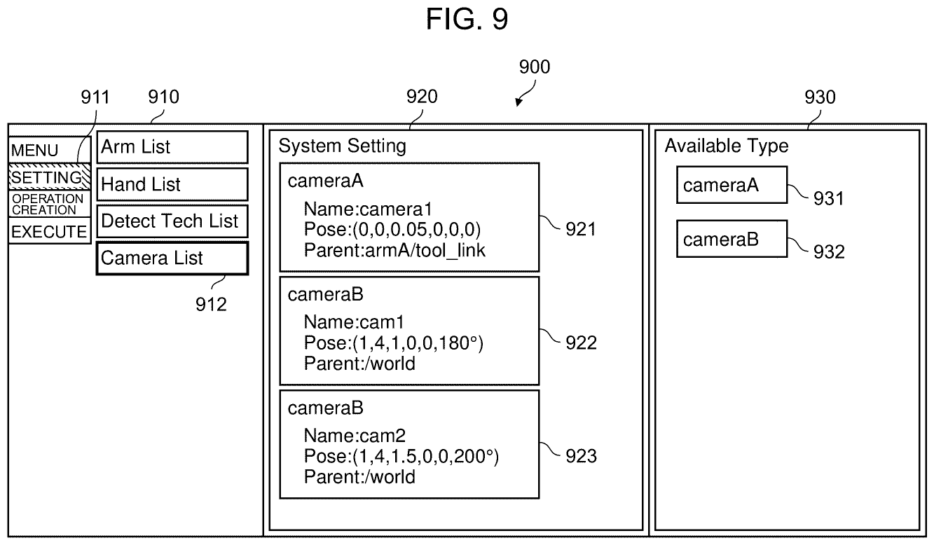

FIG. 9 shows a list of cameras (not shown) provided in the robot device. The configuration of region 910 is similar to that of region 710 of setting screen 700 in FIG. 7. In region 910, button 911 for list setting is selected. Furthermore, button 912 for setting the list of cameras is selected.

In region 920, the settings of the already registered cameras are shown. In region 930, a list of settable cameras is shown. In the present example, selection items 931 to 932 of “cameraA” and “cameraB” as the settable cameras are shown in region 930. Furthermore, in region 920, settings 921 to 923 are illustrated as settings of the already registered cameras.

For example, the following are included as setting parameters of setting 921 for the camera.
Setting target camera: cameraA
Name: camera1
Posture: (0, 0, 0.05, 0, 0, 0)
Installation destination arm: armA/tool_link
   The setting target camera indicates a setting target camera. The name indicates name information arbitrarily set to the camera. The posture indicates a reference posture of the camera, that is, a posture installed for the robot arm. The installation destination arm indicates information on the robot arm on which the camera is installed. Specifically, “armA” uniquely indicating the installation destination arm and “tool_link” uniquely indicating the coordinate system of the robot arm are illustrated. “tool_link” specifically corresponds to the arm distal end coordinate system illustrated in FIG. 1. Other settings also include similar setting parameters.

For example, when setting the operation of the robot device, the user only needs to designate position information (specifically, Target_pose) in the system coordinate system of the operation target, and does not need to designate the control parameter of each coordinate system corresponding to the configuration of the robot device as illustrated in FIG. 1. Therefore, it is not necessary to individually perform coordinate transformation on the user side according to the system configuration and then to set parameters and create an operation program.

As described above, according to an example of the present exemplary embodiment, a robot control device (for example, 100) includes: an input unit (for example, 500, 600, 101, 104, 105) that receives input of position information (for example, Target_pose) in a first coordinate system of an object to be operated by a robot device (for example, 200) and an operation setting (for example, 531 to 536 and 631 to 635) of a part (for example, 201, 202) constituting the robot device; an acquisition unit (for example, 101, 106) that acquires, based on the operation setting, a parameter (for example, robot parameter) of the part constituting the robot device and a correction value (for example, a difference between coordinate systems based on the coordinate transformation frame) for coordinate transformation between a second coordinate system (for example, the arm reference coordinate system) corresponding to the part constituting the robot device and the first coordinate system; a generation unit (for example, 101) that generates a transformation table (for example, the transformation table) for transforming position information in the first coordinate system into position information in the second coordinate system based on the correction value, the parameter, and the operation setting; and a controller (for example, 101) that transforms the position information in the first coordinate system into position information transformed into the second coordinate system by using the transformation table, and generates a control command for a part constituting the robot device using the transformed position information.

Further, according to another example of the present exemplary embodiment, a robot control device includes: an input unit that receives position information of an object to be operated by a robot device in a first coordinate system, setting information of a part constituting the robot device, and name information of the part; an acquisition unit that acquires a parameter of the part corresponding to the name information received by the input unit and a coordinate transformation frame from a database that stores the parameter of the part and the coordinate transformation frame in association with the name information of the part constituting the robot device; a generation unit that specifies a correction value that is a difference value between the first coordinate system and a second coordinate system corresponding to the part from the coordinate transformation frame acquired by the acquisition unit, and generates a transformation table for transforming position information in the first coordinate system into position information in the second coordinate system, based on the setting information of the part received by the input unit, the parameter of the part acquired by the acquisition unit, and the specified correction value; and a controller that transforms the position information in the first coordinate system into position information in the second coordinate system using the transformation table generated by the generation unit, and generates a control command for a part constituting the robot device using the position information in the second coordinate system.

As a result, it is possible to more easily set parameters related to robot control than before and to improve convenience of a system including a robot device than before. In particular, it is not necessary for the user to perform parameter setting by performing coordinate transformation for each component in consideration of the configuration of the robot device, and the burden of setting can be reduced.

Furthermore, the robot device includes a robot arm (for example, 201) and an end effector (for example, 202) provided at a distal end portion of the robot arm. The first coordinate system is a system coordinate system of a system in which the robot device is installed. The second coordinate system is any of a reference coordinate system of the robot arm, a distal end coordinate system of the distal end portion of the robot arm, a reference coordinate system of the end effector, and a target coordinate system with an arbitrary operation position of the end effector as an origin. The end effector is a robot hand or a camera.

As a result, the coordinate information of the system coordinate system can be transformed on the system side with respect to the coordinate system corresponding to the configuration of the robot device.

In addition, the acquisition unit acquires the parameters of the parts constituting the robot device and the information on the plurality of coordinate systems from the external device (for example, a database device) for each input by the input unit, and the generation unit generates the transformation table using the parameters of the parts constituting the robot device acquired from the external device and the correction values between the coordinate systems specified from the information on the plurality of coordinate systems.

As a result, it is not necessary to hold a transformation table that can be assumed by various combinations according to the operation setting, and it is possible to suppress tight storage region of the robot control device. In addition, it is possible to appropriately generate and use a transformation table corresponding to the combination of the operation setting and the robot device at that time.

Further, the part constituting the robot device is set by associating posture information in the second coordinate system corresponding to the part with name information, and the input unit receives an operation setting of the part corresponding to the name information by designating the name information. In addition, a plurality of pairs of posture information and name information can be set for one part.

As a result, the user can set desired name information and posture information, and it is possible to easily perform parameter setting only by designating the name information at the time of operation setting for the robot device. In addition, various pieces of posture information can be set also for the same part of the robot device, and the convenience at the time of operation setting can be improved.

### Other Exemplary Embodiments

In addition, it is also possible to implement processing in which a program and an application for implementing the functions of the one or more exemplary embodiments described above are supplied to a system or a device using a network, a storage medium, or the like, and one or more processors in a computer of the system or the device read and execute the program.

Alternatively, the present invention may be implemented by a circuit (for example, an application specific integrated circuit (hereinafter, ASIC) or a field programmable gate array (hereinafter, FPGA)) that implements one or more functions.

Although the various exemplary embodiments have been described above with reference to the drawings, it goes without saying that the present disclosure is not limited to such examples. It is obvious that those skilled in the art can arrive at various change examples, modification examples, replacement examples, additional examples, deletion examples, and equivalent examples within the scope described in the claims, and it is understood that these examples naturally belong to the technical scope of the present disclosure. In addition, the constituent elements included in the various exemplary embodiments described above may be voluntarily combined, within the scope not departing from the gist of the invention.

### INDUSTRIAL APPLICABILITY

The present disclosure is useful as a robot control device, a robot control method, and a program for controlling a robot device including a robot arm.

### REFERENCE MARKS IN THE DRAWINGS

100: robot control device
101: processing unit
102: storage
103: external IF
104: operation unit
105: display unit
106: communication unit
200, 210: robot device
201, 211: robot arm
202, 212: robot hand
300: database device
400: network

1. A robot control device, comprising:
an input unit that receives position information of an object to be operated by a robot device in a first coordinate system, setting information of a part constituting the robot device, and name information of the part;
an acquisition unit that acquires, from a database, a parameter and a coordinate transformation frame of the part corresponding to the name information received by the input unit, the database storing the parameter and the coordinate transformation frame of the part in association with the name information of the part constituting the robot device;
a generation unit that specifies a correction value based on the coordinate transformation frame acquired by the acquisition unit, the correction value being a difference value between the first coordinate system and a second coordinate system corresponding to the part, and generates a transformation table for transforming position information in the first coordinate system into position information in the second coordinate system based on the setting information of the part received by the input unit, the parameter of the part acquired by the acquisition unit, and the specified correction value; and
a controller that transforms position information in the first coordinate system into position information in the second coordinate system using the transformation table generated by the generation unit, and generates a control command for the part constituting the robot device using the position information in the second coordinate system.

2. The robot control device according to claim 1, wherein
the robot device includes a robot arm and an end effector provided at a distal end portion of the robot arm,
the first coordinate system is a system coordinate system of a system in which the robot device is installed, and
the second coordinate system is any of a reference coordinate system of the robot arm, a distal end coordinate system of a distal end portion of the robot arm, a reference coordinate system of the end effector, and a target coordinate system with an arbitrary operation position of the end effector as an origin.

3. The robot control device according to claim 2, wherein the end effector is a robot hand or a camera.

4. The robot control device according to claim 1, wherein
the database is provided in an external device configured to be communicable with the robot control device, and
the acquisition unit acquires the parameter of the part and the coordinate transformation frame from the database when the input unit receives the setting information of the part and the name information of the part.

5. The robot control device according to claim 1, wherein in the database, posture information in the second coordinate system corresponding to the part constituting the robot device as the parameter of the part is associated with the name information of the part.

6. The robot control device according to claim 5, wherein the database stores a plurality of pairs of the posture information of the part and the name information of the part.

7. A robot control method comprising:
receiving position information of an object to be operated by a robot device in a first coordinate system, setting information of a part constituting the robot device, and name information of the part;
acquiring, from a database, a parameter and a coordinate transformation frame of the part corresponding to the received name information, the database storing the parameter and the coordinate transformation frame of the part in association with the name information of the part constituting the robot device;
specifying a correction value based on the acquired coordinate transformation frame, the correction value being a difference value between the first coordinate system and a second coordinate system corresponding to the part, and generating a transformation table for transforming position information in the first coordinate system into position information in the second coordinate system based on the received setting information of the part, the acquired parameter of the part, and the specified correction value; and
transforming position information in the first coordinate system into position information in the second coordinate system using the generated transformation table, and generating a control command for the part constituting the robot device using the position information in the second coordinate system.

8. A program for causing a computer to execute a robot control method comprising:
receiving position information of an object to be operated by a robot device in a first coordinate system, setting information of a part constituting the robot device, and name information of the part;
acquiring, from a database, a parameter and a coordinate transformation frame of the part corresponding to the received name information, the database storing the parameter and the coordinate transformation frame of the part in association with the name information of the part constituting the robot device;
specifying a correction value based on the acquired coordinate transformation frame, the correction value being a difference value between the first coordinate system and a second coordinate system corresponding to the part, and generating a transformation table for transforming position information in the first coordinate system into position information in the second coordinate system based on the received setting information of the part, the acquired parameter of the part, and the specified correction value; and
transforming position information in the first coordinate system into position information in the second coordinate system using the generated transformation table, and generating a control command for the part constituting the robot device using the position information in the second coordinate system.

9. A robot control device, comprising:
an input unit that receives input of position information of an object to be operated by a robot device in a first coordinate system and an operation setting of a part constituting the robot device;
an acquisition unit that acquires, based on the operation setting, a parameter of the part constituting the robot device and a correction value for coordinate transformation between a second coordinate system corresponding to the part constituting the robot device and the first coordinate system;
a generation unit that generates a transformation table for transforming the position information in the first coordinate system into position information in the second coordinate system based on the correction value, the parameter, and the operation setting; and
a controller that transforms the position information in the first coordinate system into the position information in the second coordinate system by using the transformation table, and generates a control command for the part constituting the robot device by using the position information in the second coordinate system.

10. The robot control device according to claim 9, wherein
the robot device includes a robot arm and an end effector provided at a distal end portion of the robot arm,
the first coordinate system is a system coordinate system of a system in which the robot device is installed, and
the second coordinate system is any of a reference coordinate system of the robot arm, a distal end coordinate system of a distal end portion of the robot arm, a reference coordinate system of the end effector, and a target coordinate system with an arbitrary operation position of the end effector as an origin.

11. The robot control device according to claim 10, wherein the end effector is a robot hand or a camera.

12. The robot control device according to claim 9, wherein
the input unit receives a plurality of the inputs,
for each of the plurality of inputs by the input unit, the acquisition unit acquires a parameter of the part constituting the robot device and information on a plurality of coordinate systems from an external device, and
the generation unit generates the transformation table using the parameter of the part constituting the robot device acquired from the external device and a correction value between coordinate systems specified from information of the plurality of coordinate systems.

13. The robot control device according to claim 9, wherein
name information is set to the part constituting the robot device in association with each other, and
the input unit receives the operation setting of the part corresponding to the name information by designating the name information.

14. The robot control device according to claim 13, wherein a plurality of pieces of the name information is settable for the part.

15. A robot control method, comprising:
receiving input of position information of an object to be operated by a robot device in a first coordinate system and an operation setting of a part constituting the robot device;
acquiring, based on the operation setting, a parameter of a part constituting the robot device and a correction value for coordinate transformation between a second coordinate system corresponding to the part constituting the robot device and the first coordinate system;
generating a transformation table for transforming the position information in the first coordinate system into position information in the second coordinate system based on the correction value, the parameter, and the operation setting; and
transforming the position information in the first coordinate system into the position information in the second coordinate system using the transformation table, and generating a control command for the part constituting the robot device using the position information in the second coordinate system.

16. A program for causing a computer to execute a robot control method comprising:
receiving input of position information of an object to be operated by a robot device in a first coordinate system and an operation setting of a part constituting the robot device;
acquiring, based on the operation setting, a parameter of a part constituting the robot device and a correction value for coordinate transformation between a second coordinate system corresponding to the part constituting the robot device and the first coordinate system;
generating a transformation table for transforming the position information in the first coordinate system into position information in the second coordinate system based on the correction value, the parameter, and the operation setting; and
transforming the position information in the first coordinate system into the position information in the second coordinate system using the transformation table, and generating a control command for the part constituting the robot device using the position information in the second coordinate system.
